(19) United States
(12) Patent Application Publication
(10) Pub. No.: US 2013/0029242 A1
(43) Pub. Date: Jan. 31, 2013

(54) MEMBRANE ELECTRODE ASSEMBLY AND FUEL CELL USING SAME

(71) Applicants: Hirotaka Mizuhata, Osaka-shi (JP); Tomohisa Yoshie, Osaka-shi (JP); Shinobu Takenaka, Osaka-shi (JP); Takenori Onishi, Osaka-shi (JP); Masashi Muraoka, Osaka-shi (JP)

(72) Inventors: Hirotaka Mizuhata, Osaka-shi (JP); Tomohisa Yoshie, Osaka-shi (JP); Shinobu Takenaka, Osaka-shi (JP); Takenori Onishi, Osaka-shi (JP); Masashi Muraoka, Osaka-shi (JP)

(73) Assignee: SHARP KABUSHIKI KAISHA, Osaka-shi, Osaka (JP)

(21) Appl. No.: 13/640,546

(22) PCT Filed: Feb. 3, 2011
(86) PCT No.: PCT/JP2011/052240

§ 371 Date: Oct. 11, 2012

(30) Foreign Application Priority Data
Apr. 12, 2010 (JP) 2010-091244

(51) Int. Cl. H01M 8/04; H01M 8/10

(52) U.S. Cl. 429/442

(57) ABSTRACT

A membrane electrode assembly having a temperature responsive layer whose material permeability is reduced with temperature rise, on a laminate including an anode catalyst layer, an electrolyte membrane and a cathode catalyst layer in this order, and a fuel cell using the same are provided. The temperature responsive layer may be composed of a porous layer containing a temperature responsive material whose moisture content changes at a phase transition temperature. It is possible to repress increase in fuel supply amount to the anode catalyst layer in association with temperature rise, and moisture evaporation from the electrolyte membrane in association with temperature rise, and to prevent excessive temperature rise and thermal runaway of the fuel cell.

### TECHNICAL FIELD

The present invention relates to a membrane electrode assembly, and more specifically to a membrane electrode assembly having a temperature responsive layer whose material permeability is reduced with temperature rise. Also, the present invention relates to a fuel cell using the membrane electrode assembly.

### BACKGROUND ART

Practical use of a fuel cell as a novel power source for potable electronics that support the information society is increasingly expected in the point of long-time drive that enables an user to use the electronic device for a longer time by replenishing the fuel once, and in the point of convenience that enables a user to use the electronic device immediately after consumption of the battery outside the home, by buying fuel and replenishing the same without waiting for charge of the battery.

The temperature of a fuel cell tends to increase in association with power generation. When the temperature of the fuel cell excessively increases, moisture in an electrolyte membrane is short in association with moisture evaporation of the electrolyte membrane and as a result, resistance of the fuel cell increases, and the current cannot be sufficiently taken out.

As a means for preventing moisture shortage of the electrolyte membrane, for example, Japanese Patent Laying-Open No. 2008-288045 (Patent literature 1) describes using as an electrolyte membrane of a fuel cell, an ion conductive membrane formed of a polymer film having segment (A) including a component having ion conductivity and segment (B) including a component whose solubility, shape or volume reversibly changes by external stimulus. It is described that segment (B) is a component whose property reversibly changes between hydrophilicity/hydrophobicity by temperature change, and when the membrane temperature reaches greater than or equal to the phase transition temperature by internal heat generation by cell reaction, the water retained by segment (B) is discharged, and as a result, segment (A) exhibiting ion conductivity is moisturized.

By the way, a so-called passive type fuel cell that supplies fuel and air, respectively to an anode electrode and an cathode electrode without using auxiliary machinery using external power such as a pump or a fan has a possibility of realizing a very small miniaturized fuel cell, so that expectation for its application to be mounted on a portable electronic device recently rises. In particular, in such a passive type fuel cell, when the fuel amount supplied to the anode electrode is large, relative to the fuel amount consumed by power generation, crossover of the fuel in which the fuel permeates through the electrolyte membrane and burns on the cathode electrode side occurs, and the cell temperature excessively rises. This excessive temperature rise of the cell leads increases in the fuel supply amount to the anode electrode and in the fuel permeation amount of the electrolyte membrane, and as a result, accelerates the temperature rise of the cell, which may lead thermal runaway. This problem of thermal runway is particularly significant in a passive type fuel cell in which fuel is vaporized, and the fuel in a gas state is supplied to the anode electrode.

Such thermal runway also causes moisture evaporation in the electrolyte membrane, and increases resistance of the fuel cell, so that it becomes impossible to take out sufficient current. Further, since the fuel amount consumed by power generation becomes smaller than the amount of crossovering fuel, the fuel use efficiency decreases, and increase in cell volume is caused.

As a means for preventing increase of crossover of the fuel in association with temperature rise of the cell, for example, Japanese Patent Laying-Open No. 2006-085955 (Patent literature 2) describes that by interposing an intermediate layer that has proton conductivity and experiences reversible change in volume accompanied by contraction by temperature rise, between a catalyst electrode and a solid polymer electrolyte membrane, migration of moisture and fuel is blocked by the intermediate layer in a high temperature region where the amount of liquid fuel permeating through the solid polymer electrolyte membrane tends to increase, and waste of the liquid fuel can be repressed.

### CITATION LIST

### Patent Literature

PTL 1: Japanese Patent Laying-Open No.2008-288045

PTL 2: Japanese Patent Laying-Open No.2006-085955

### SUMMARY OF INVENTION

### Technical Problem

As disclosed in the Patent literatures 1 and 2, when an external stimulus responsive material is used as a means for preventing moisture shortage in an electrolyte membrane or crossover of fuel, in a laminate (membrane electrode assembly in a narrow sense) made up of an anode catalyst layer, the electrolyte membrane and a cathode catalyst layer, there is a problem that swelling/contraction of the external stimulus responsive material caused by external stimulus generates a stress and leads breakage of the laminate. Further, when the external stimulus responsive material is used in the laminate, there is a problem that chemical reaction and migration of substances, migration of electrons and ions occurring inside the laminate are prevented, and the power generating characteristic is reduced.

The present invention was devised in consideration of these problems of conventional arts, and it is an object of the present invention to provide a membrane electrode assembly capable of repressing increase in the amount of fuel supplied to the anode catalyst layer in association with temperature rise, and/or repressing moisture evaporation from the electrolyte membrane in association with temperature rise, and thus achieving excellent power generating characteristic without causing excessive temperature rise and thermal runway, and a fuel cell using the same.

### Solution to Problem

The present invention provides a membrane electrode assembly having a temperature responsive layer whose material permeability is reduced with temperature rise, on a laminate including an anode catalyst layer, an electrolyte membrane and a cathode catalyst layer in this order. Preferably, the membrane electrode assembly of the present invention has a temperature responsive layer on at least either one catalyst layer of the anode catalyst layer or the cathode catalyst layer.

Preferably, the temperature responsive layer is composed of a porous layer containing a temperature responsive material whose moisture content changes at a phase transition temperature. For example, the temperature responsive material is retained in pores of the porous layer. The temperature responsive material may be chemically bound to a wall of the pores of the porous layer.

In one preferred embodiment of the membrane electrode assembly of the present invention, the temperature responsive material has concentration distribution in a planar direction of the temperature responsive layer. In other preferred embodiment, the temperature responsive material has concentration distribution along a film thickness of the temperature responsive layer.

As the temperature responsive material, a material exhibiting upper critical solution temperature (UCST) type phase transition behavior or a material exhibiting lower critical solution temperature (LCST) type phase transition behavior may be preferably used.

Preferably, the phase transition temperature of the temperature responsive material is lower than the boiling point of fuel supplied to the anode catalyst layer by greater than or equal to 5° C. Preferably, the porous layer is composed of a non-temperature responsive material (material not exhibiting temperature responsibility).

The membrane electrode assembly of the present invention may have an anode gas diffusion layer stacked on the anode catalyst layer and a cathode gas diffusion layer stacked on the cathode catalyst layer. In this case, the membrane electrode assembly of the present invention may have the temperature responsive layer as the anode gas diffusion layer and/or the cathode gas diffusion layer.

Also, the present invention provides a fuel cell including: the membrane electrode assembly according to the present invention as described above; an anode collector stacked on the side of the anode catalyst layer of the membrane electrode assembly; a cathode collector stacked on the side of the cathode catalyst layer of the membrane electrode assembly; and a fuel supply unit disposed on the side of the anode catalyst layer of the membrane electrode assembly. The fuel cell of the present invention is preferably a direct alcohol type fuel cell, and more preferably a direct methanol type fuel cell.

### Advantageous Effects of Invention

According to the present invention, it is possible to provide a membrane electrode assembly and a fuel cell capable of repressing increase in the amount of fuel supplied to the anode catalyst layer in association with temperature rise, and/or repressing moisture evaporation from the electrolyte membrane in association with temperature rise, and thus achieving excellent power generating characteristic without causing excessive temperature rise and thermal runway. The fuel cell containing the membrane electrode assembly of the present invention is suited as a miniature fuel cell intended for application to various electronics, particularly portable electronics, in particular, as a miniature fuel cell to be mounted on a portable electronic device.

### BRIEF DESCRIPTION OF DRAWINGS

FIG. 1 is a section view schematically showing one example of a membrane electrode assembly of the present invention.

FIG. 2 is a schematic view illustrating material permeability control using a polymer exhibiting LCST type phase transition behavior.

FIG. 3 is a schematic view illustrating material permeability control using a polymer exhibiting UCST type phase transition behavior.

FIG. 4 is a section view schematically showing another example of a membrane electrode assembly of the present invention.

FIG. 5 is a section view schematically showing one example of a fuel cell of the present invention.

FIG. 6 is a section view schematically showing a fuel cell fabricated in Example 3.

FIG. 7 is a section view schematically showing a fuel cell fabricated in Example 4.

FIG. 8 is a section view schematically showing a fuel cell fabricated in Example 5.

FIG. 9 is a section view schematically showing a fuel cell fabricated in Examples 6 and 7.

FIG. 10 is a section view schematically showing a fuel cell fabricated in Example 8.

FIG. 11 is a section view schematically showing a fuel cell fabricated in Example 9.

FIG. 12 is a section view schematically showing a fuel cell fabricated in Example 10.

FIG. 13 is a section view schematically showing a fuel cell fabricated in Comparative Example 1.

FIG. 14 is a view showing the relationship between the position along a film thickness of the temperature responsive layers fabricated in Examples 1, 2, 4, Comparative Examples 2 and 3, and the fill factor of the temperature responsive layer retained in the porous layer.

FIG. 15 is a view showing the temperature dependency of methanol permeability of the temperature responsive layers fabricated in Examples 1 to 5 and Comparative Examples 2 to 3.

### DESCRIPTION OF EMBODIMENTS

In the following, a membrane electrode assembly and a fuel cell of the present invention will be described specifically by way of embodiments.

<Membrane Electrode Assembly>

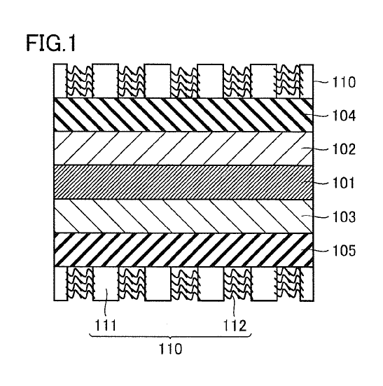

FIG. 1 is a section view schematically showing one example of a membrane electrode assembly of the present invention. The membrane electrode assembly shown in FIG. 1 includes a laminate including an anode catalyst layer 102, an electrolyte membrane 101 and a cathode catalyst layer 103 in this order; an anode gas diffusion layer 104 stacked in contact with anode catalyst layer 102; a cathode gas diffusion layer 105 stacked in contact with cathode catalyst layer 103; and two temperature responsive layers 110 respectively stacked in contact with anode gas diffusion layer 104 and cathode gas diffusion layer 105. In the following, each layer constituting the membrane electrode assembly of the present embodiment will be specifically described.

(1) Temperature Responsive Layer

The membrane electrode assembly of the present embodiment has two temperature responsive layers 110 respectively stacked on the side of anode catalyst layer 102 and on the side of cathode catalyst layer 103. Temperature responsive layer 110 has such a property that material permeability is reduced with temperature rise. The material permeability of temperature responsive layer 110 changes preferably reversibly and discontinuously at a predetermined temperature. The “material” used herein means a material that is able to migrate through the temperature responsive layer when the membrane electrode assembly is applied to a fuel cell, and concretely, it is fuel for the fuel cell (hereinafter, simply called fuel) and/or water. For example, when the membrane electrode assembly is applied to a direct alcohol type fuel cell, the fuel is alcohol or an alcohol aqueous solution.

The fact that the material permeability of temperature responsive layer 110 reversibly changes is advantageous in the point of continuous operation of the fuel cell containing the membrane electrode assembly. In other words, even when the temperature of the fuel cell excessively rises, the material permeability of the temperature responsive layer will be recovered (increased) simply with temperature decrease of the fuel cell, and the fuel cell is enabled to operate in the same manner as before excessive increase in the temperature of the fuel cell. The fact that “the material permeability of temperature responsive layer 110 changes discontinuously (“discontinuously” means that the material permeability dramatically changes at a predetermined temperature)” is advantageous in that the permeability of fuel or water is significantly reduced at the predetermined temperature or higher, and a desired effect can be obtained reliably and effectively.

According to the membrane electrode assembly of the present embodiment, by having temperature responsive layer 110, the following effects can be obtained. That is, by disposing temperature responsive layer 110 outside anode gas diffusion layer 104, it is possible to repress the increase in the amount of fuel permeation to anode catalyst layer 102 in association with temperature rise in the membrane electrode assembly. By repression of the increase in the amount of fuel permeation, thermal runaway can be repressed, and as a result, moisture evaporation from electrolyte membrane 101 in association with temperature rise can be repressed. Further, by repression of the increase in the amount of fuel permeation, the use efficiency of the fuel increases, so that the fuel volume and the volume of fuel storage bath can be reduced when the temperature responsive layer is used in a fuel cell. Further, the ability to repress the thermal runaway improves the safety and prevents irreversible thermal deterioration of the membrane electrode assembly and the fuel cell using the same, leading improvement in reliability of the same. Further, since moisture evaporation from electrolyte membrane 101 can be repressed, it is possible to prevent the increase in resistance of the fuel cell using the membrane electrode assembly and accompanying decrease in power generating efficiency. This also contributes to reduction in the cell volume.

On the other hand, by disposing temperature responsive layer 110 outside cathode gas diffusion layer 105, it is possible to repress moisture evaporation from electrolyte membrane 101 in association with temperature rise in the membrane electrode assembly. Since moisture evaporation can be repressed, it is possible to prevent the increase in resistance of the fuel cell using the membrane electrode assembly and accompanying decrease in power generating efficiency. This also contributes to reduction in the cell volume.

As in the present embodiment, in the present invention, the temperature responsive layer is disposed outside (external to) the laminate made up of the anode catalyst layer, the electrolyte membrane and the cathode catalyst layer (membrane electrode assembly in a narrow sense). By disposing the temperature responsive layer outside (external to) the laminate, it is possible to prevent the laminate from being structurally broken even when the volume changes with change in material permeability of the temperature responsive layer, and to realize a membrane electrode assembly and a fuel cell having high reliability. Further, by disposing the temperature responsive layer outside (external to) the laminate, chemical reactions and migrations of materials, migrations of electrons and ions generated in the laminate will not be hindered, so that high power generating efficiency can be realized.

The thickness of temperature responsive layer 110 is preferably 50 to 500 μm. When the thickness is too small, the mechanical strength is poor and the reliability may be impaired, for example, by occurrence of breakage. On the other hand, when the thickness of temperature responsive layer 110 is too large, the volume of the fuel cell to which the membrane electrode assembly is applied increases.

Temperature responsive layer 110 in the present embodiment includes temperature responsive material 112, and more concretely, it is composed of porous layer 111 containing temperature responsive material 112. The temperature responsive material is, as will be specifically described, a material whose moisture content changes at a predetermined temperature such as phase transition temperature. As schematically shown in FIG. 1, temperature responsive layer 110 is preferably a layer in which temperature responsive material 112 is retained in pores of porous layer 111.

[a] Porous Layer

While porous layer 111 constituting temperature responsive layer 110 may have temperature responsibility, it is preferably formed of a non-temperature responsive material (material not having temperature responsibility) because the dimensional change of temperature responsive layer 110 can be repressed by volume change in association with the change in moisture content of temperature responsive material 112 as well. The non-temperature responsive material concretely refers to a material whose physical properties such as moisture content, volume, hydrophilicity and hydrophobicity will not change discontinuously change (“discontinuously” means that physical property values dramatically change at a phase transition temperature or the like).

As porous layer 111, for example, a resin porous film formed of polyethylene tetrafluoride, polyvinylidene fluoride and polyolefin such as poly ethylene may be desirably used. Concrete examples of the resin porous film include “TEMISH” (available from NITTO DENKO CORPORATION) which is a polyethylene tetrafluoride resin porous film, “SUNMAP” (available from NITTO DENKO CORPORATION) which is a polyethylene resin porous film, and “Hipore” (available from Asahi Kasei Corporation) which is a polyolefin resin porous film, by trade names.

Also, porous films that are commonly used as a gas diffusion layer such as carbon paper and carbon cloth, and inorganic porous films of foam metal, porous ceramics and the like may be used. When a porous film that is commonly used as a gas diffusion layer is used as porous layer 111, the response speed of the material permeability of temperature responsive layer 110 is further improved owing to its high thermal conductivity, so that it is possible to obtain a membrane electrode assembly and a fuel cell that are less likely to cause thermal runway or the like and have higher reliability.

On the other hand, of the aforementioned resin porous films, it is preferred to use a film of fluorine based resin such as polyethylene tetrafluoride or polyvinylidene fluoride. Since the porous layer formed of fluorine based resin has water repellency, it will not hinder gas permeation, while preventing permeation and condensation of an alcohol aqueous solution (for example, methanol aqueous solution) that may be used as liquid fuel or water. Therefore, when a temperature responsive layer using a porous layer formed of fluorine based resin is provided on the side of the cathode electrode, pores of the porous layer will not be clogged with water generated by power generation, and supply of air will not be prevented, so that stable power generation is realized. When a temperature responsive layer using a porous layer formed of fluorine based resin is provided on the side of the anode electrode, the alcohol aqueous solution which is liquid fuel fails to permeate by itself, but alcohol vapor (for example, methanol vapor) and water vapor generated by vaporization permeate, so that the fuel supply amount to anode catalyst layer 102 can be repressed, and use of high concentration fuel (for example, alcohol aqueous solution having high alcohol concentration) is enabled.

While the pore structure of porous layer 111 is not particularly limited, the structure having pores with an average pore diameter of greater than or equal to 50 nm is preferred for the ease of compositing with temperature responsive material 112. When the average pore diameter is, for example, less than 50 nm, the pores are too small, and it becomes difficult to allow the temperature responsive material to permeate into the pores of the porous layer and to be retained therein.

The pore structure of porous layer 111 may be such a structure that pores are distributed in a network form in the porous layer (the structure in which pores communicate each other three-dimensionally), or may have a large number of pores penetrating along a film thickness. Porosity of porous layer 111 is preferably 70 to 95%. When the porosity is less than 70%, the material permeability of temperature responsive layer 110 is extremely small, so that stable power generation cannot be achieved when power generation is conducted at a high current density that requires plenty of air and fuel. When the porosity exceeds 95%, the strength of the porous layer decreases, and dimensional change of the temperature responsive layer cannot be repressed when the volume changes in association with the change in the moisture content of the temperature responsive material. The average pore diameter and the porosity as described above are values determined by measuring pore distribution according to a mercury intrusion method.

Porous layer 111 may be a composite layer made up of a first porous layer having a larger average pore diameter and a larger film thickness, and a second porous layer having a smaller average pore diameter and a smaller film thickness. Temperature responsive layer 110 using porous layer 111 formed of such a composite layer is able to keep the mechanical strength sufficiently without significant impairment of the material permeability by the first porous layer, and to improve the reliability of the membrane electrode assembly and the fuel cell.

[b] Temperature Responsive Material

Temperature responsive material 112 is a material whose moisture content changes at a predetermined temperature such as phase transition temperature. Preferred examples of materials whose moisture content changes at a predetermined temperature include materials whose moisture content changes at a predetermined temperature to experience change in volume; and materials whose moisture content changes at a predetermined temperature to experience change in physical property from hydrophilicity to hydrophobicity or from hydrophobicity to hydrophilicity. In these materials, the volume or the physical property change reversibly and discontinuously (“discontinuously” means that these physical property values dramatically change at a phase transition temperature or the like).

As temperature responsive material 112, polymers exhibiting the temperature response as described above can be preferably used. Such polymers include polymers exhibiting lower critical solution temperature (LCST) type phase transition behavior in which the polymer dehydrates at a temperature greater than or equal to the phase transition temperature and hydrates at a temperature less than the phase transition temperature, and polymers exhibiting upper critical solution temperature (UCST) type phase transition behavior in which the polymer dehydrates at a temperature less than or equal to the phase transition temperature and hydrates at a temperature greater than the phase transition temperature. When such a temperature responsive polymer is used as a temperature responsive material, the change in volume at the phase transition temperature may be utilized to control the material permeability, or the change between hydrophilicity/hydrophobicity at the phase transition temperature may be utilized to control the material permeability.

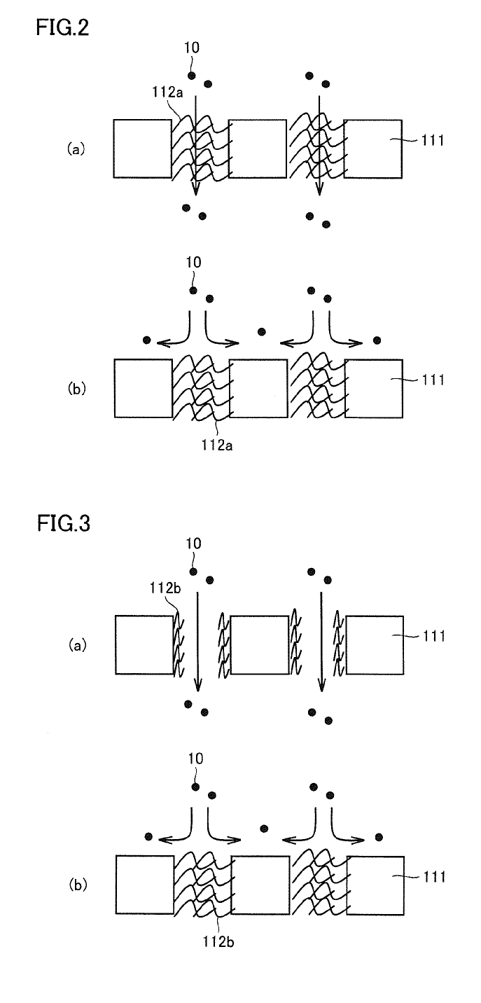

A polymer exhibiting LCST type phase transition behavior (hereinafter, referred to as a LCST type polymer) changes from a hydrated state to a dehydrated state, namely changes from hydrophilic to hydrophobic (the moisture content decreases) at the phase transition temperature in association with temperature rise. By using the LCST type polymer as temperature responsive material 112, as shown in FIG. 2, it is possible to repress the permeation of water and fuel such as methanol or a methanol aqueous solution which are hydrophilic after phase transition, in comparison with before the phase transition. FIG. 2(a) schematically shows the condition that the temperature of the membrane electrode assembly is less than the phase transition temperature, and permeation of water or methanol 10 is not repressed by a hydrophilic

LCST type polymer 112a which is temperature responsive material 112, and FIG. 2(b) schematically shows the condition that the temperature of the membrane electrode assembly is greater than or equal to the phase transition temperature, and permeation of water or methanol 10 is repressed by LCST type polymer 112a which has been changed to hydrophobic. In this manner, by using LCST type polymer 112a as temperature responsive material 112, it is possible to reduce the material permeability of temperature responsive layer 110 at a temperature of greater than or equal to the phase transition temperature.

When temperature responsive layer 110 is formed by retaining LCST type polymer 112a in pores of porous layer 111, it is important to make the fill amount of LCST type polymer 112a in pores sufficiently high so that the material permeation amount is sufficiently repressed at a temperature greater than or equal to the phase transition temperature. To be more specific, LCST type polymer 112a changes from a hydrated state to a dehydrated state at a temperature greater than or equal to the phase transition temperature, and in association with this, the polymer contracts. This is because even if pores of porous layer 111 are clogged with LCST type polymer 112a when the polymer is swelled at a temperature less than the phase transition temperature, the material permeation amount can increase when the polymer contracts and the clogged pores are open at a temperature greater than or equal to the phase transition temperature.

Examples of LCST type polymer 112a include poly (N-substituted acrylamide) derivatives such as poly-N-vinylisobutylamide and poly-N-isopropyl (meth)acrylamide; polyethers such as polyethylene glycol/polypropylene glycol copolymer, and polyethylene oxide; cellulose derivatives such as methyl cellulose, ethyl cellulose, hydroxyethyl cellulose and hydroxypropyl cellulose; and copolymers or polymer blends based on any one of the above polymer compounds.

The phase transition temperature of LCST type polymer 112a may be controlled by the kind of polymer, the copolymerization ratio or the like. For example, poly-N-isopropylacrylamide exhibits phase transition at a temperature of 30.9° C., poly-N-isopropylmethacryl amide exhibits phase transition at a temperature of 44° C., poly-N-ethylmethacrylamide exhibits phase transition at a temperature of 50° C., poly-N-cyclopropylmethacrylamide exhibits phase transition at a temperature of 59° C., and poly-N-ethylacrylamide exhibits phase transition at a temperature of 72° C. Copolymer of N-isopropylacrylamide and dimethylacrylamide exhibits phase transition at a temperature of 34° C. when the molar fraction of dimethylacrylamide is 6.4%, and 41° C. when the molar fraction is 17.2%.

The phase transition temperature of LCST type polymer 112a (ditto for the case of using other temperature responsive material) should be appropriately selected depending on the operation temperature of the fuel cell using the membrane electrode assembly and the kind of fuel to be used, and for example, the phase transition temperature of LCST type polymer 112a is preferably lower than the boiling point of the fuel supplied to the anode catalyst layer by greater than or equal to 5° C. When the difference between the boiling point of the fuel and the phase transition temperature is less than 5° C., permeation of fuel and water will not be repressed unless the temperature of the fuel cell is significantly high and such a condition that the amounts of vaporized fuel and water rapidly increase is achieved, so that there is sometimes the case that moisture evaporation from the electrolyte membrane cannot be sufficiently repressed, and reduction in power generating efficiency cannot be effectively repressed.

Next, a polymer exhibiting UCST type phase transition behavior (hereinafter, referred to as UCST type polymer) will be described. An UCST type polymer is a temperature responsive material which changes from a dehydrated state to a hydrated state, namely from hydrophobicity to hydrophilicity (moisture content increases), at the phase transition temperature in association with temperature rise. When the UCST type polymer is used as temperature responsive material 112, it is possible to control the material permeability by utilizing the volume change at the time of change from the dehydrated state to the hydrated state. That is, as shown in FIG. 3, by the expansion of the volume of the UCST type polymer, it is possible to repress the permeation of water and fuel such as methanol or a methanol aqueous solution after the phase transition, in comparison with before the phase transition. FIG. 3(a) schematically shows the condition that the temperature of the membrane electrode assembly is less than or equal to the phase transition temperature, and UCST type polymer 112b contracts in a dehydrated state, so that pores of porous layer 111 in which UCST type polymer 112b is retained are open, and permeation of water or methanol 10 is not repressed by UCST type polymer 112b, and FIG. 3(b) schematically shows the condition that the temperature of the membrane electrode assembly exceeds the phase transition temperature, and UCST type polymer 112b swells in a hydrated state, so that the pores are clogged and permeation of water or methanol 10 is repressed by UCST type polymer 112b. In this manner, when UCST type polymer 112b is used as temperature responsive material 112, it is possible to reduce the material permeability of temperature responsive layer 110 by clogging pores with swelled UCST type polymer 112b.

Since the temperature responsive layer using the UCST type polymer controls the amount of permeation of water or fuel by opening/closing of pores of the porous layer, the variation in the amount of permeation between before and after phase transition temperature tends to be larger in comparison with that by the temperature responsive layer using change between hydrophilicity/hydrophobicity of the LCST type polymer. Therefore, the temperature responsive layer using the UCST type polymer is particularly effective when the temperatures of the membrane electrode assembly and the fuel cell are not intended to be increase over a certain temperature, and is particularly advantageous in that temperature fluctuation of the membrane electrode assembly and the fuel cell can be further reduced.

When temperature responsive layer 110 is formed by retaining UCST type polymer 112b in pores of porous layer 111, it is important to set the fill amount of UCST type polymer 112b in pores sufficiently small so that the material permeation amount at a temperature less than or equal to the phase transition temperature is larger than the material permeation amount at a temperature exceeding the phase transition temperature. To be more specific, UCST type polymer 112b changes from a hydrated state to a dehydrated state at a temperature less than or equal to the phase transition temperature, and in association with this, the polymer contracts. If pores of porous layer 111 are clogged with UCST type polymer 112b even when the polymer contracts at a temperature less than or equal to the phase transition temperature, opening/closing of pores of porous layer 111 will not occur before and after the phase transition temperature, so that the material permeation amount cannot be reduced at a temperature even when exceeding the phase transition temperature, and when the temperature exceeds the phase transition temperature, UCST type polymer 112b changes from hydrophobicity to hydrophilicity, so that the material permeation amount can rather increase.

Examples of UCST type polymer 112b include linear polyethyleneimine, sulfobetaine polymer, and copolymer of acrylamide and N-acetylacrylamide. The phase transition temperature of linear polyethyleneimine is 59.5° C. Phase transition temperature of UCST type polymer 112b can be controlled by the kind, copolymerization ratio and the like of polymer.

Likewise LCST type polymer 112a, UCST type polymer 112b preferably has a phase transition temperature lower than the boiling point of the fuel supplied to the anode catalyst layer by greater than or equal to 5° C. When the difference between the boiling point of the fuel and the phase transition temperature is less than 5° C., permeation of fuel and water will not be repressed unless the temperature of the fuel cell is significantly high and such a condition that the amounts of vaporized fuel and water rapidly increase is achieved, so that there is sometimes the case that moisture evaporation from the electrolyte membrane cannot be sufficiently repressed, and reduction in power generating efficiency cannot be effectively repressed.

Change between hydrophilicity/hydrophobicity at the phase transition temperature of UCST type polymer 112b may be used for controlling the material permeability. That is, since UCST type polymer 112b changes from a dehydrated state to a hydrated state, namely changes from hydrophobic to hydrophilic at the phase transition temperature in association with temperature rise, when hydrophobic fuel is used, it is possible to reduce the permeability for the fuel at the phase transition temperature. As hydrophobic fuel, for example, dimethyl ether is recited.

[e] Fabrication of Temperature Responsive Layer

Temperature responsive layer 110 in which temperature responsive material 112 is retained in pores of porous layer 111 as shown in FIG. 1 may be obtained by immersing inside pores of porous layer 111 with temperature responsive material 112. The method for immersion is not particularly limited, and for example, a method of dipping porous layer 111 in a solution containing temperature responsive material 112 is recited. Also, temperature responsive material 112 may be chemically bonded with a wall of pores of porous layer 111, and for example, temperature responsive material 112 may be grafted to a wall of pores of porous layer 111. One exemplary method for grafting temperature responsive material 112 on a wall of pores of porous layer 111 includes irradiating porous layer 111 with plasma or radiation to generate radicals on the surface of pores, and dipping it in a solution containing a monomer component that forms temperature responsive material 112 to allow polymerization to proceed.

Here, temperature responsive material 112 may be distributed uniformly or approximately uniformly in a planar direction of temperature responsive layer 110, or may have a concentration distribution in the planar direction. One exemplary case where temperature responsive material 112 has a concentration distribution in the planar direction of temperature responsive layer 110 includes the case that not all of pores in porous layer 111 are filled with temperature responsive material 112, but part of pores are filled with temperature responsive material 112. By adjusting the proportion of pores that are filled with temperature responsive material 112, it is possible to control the minimum material permeation amount of temperature responsive layer 110 (material permeation amount of temperature responsive layer 110 when temperature responsive material 112 exerts the maximum material permeation repressing function). That is, by reducing the proportion of pores that are filled with temperature responsive material 112, it is possible to increase the minimum material permeation amount of temperature responsive layer 110. For example, the fuel cell using the membrane electrode assembly whose minimum material permeation amount is adjusted to relatively high level is advantageous in the case of generating power at high current density that requires plenty of air and fuel, and allows stable power generation in such a case.

Temperature responsive material 112 may be distributed uniformly or approximately uniformly along a film thickness of temperature responsive layer 110, or may have a concentration distribution along the film thickness. The expression “uniformly or approximately uniformly distributed along the film thickness” means that the fill density of temperature responsive material 112 along the film thickness is identical or approximately identical. As the case where temperature responsive material 112 has a concentration distribution along the film thickness of temperature responsive layer 110, for example, the case where the fill density of temperature responsive material 112 differs between one part and another part along the film thickness of temperature responsive layer 110 in pores is recited. Also by adjusting the concentration distribution of temperature responsive material 112 along the film thickness of temperature responsive layer 110, it is possible to control the minimum material permeation amount of temperature responsive layer 110. That is, by increasing the part having relatively low fill density of temperature responsive material 112, it is possible to increase the minimum material permeation amount of temperature responsive layer 110.

(2) Electrolyte Membrane

Electrolyte membrane 101 has a function of transferring ions between anode catalyst layer 102 and cathode catalyst layer 103, and a function of keeping electric insulation between anode catalyst layer 102 and cathode catalyst layer 103 to prevent short-circuiting. The material of electrolyte membrane 101 is not particularly limited insofar as it has ion conductivity and electric insulating property, and a polymer membrane, an inorganic membrane or a composite membrane may be used. Examples of polymer membranes include perfluorosulfonic acid based electrolyte membranes such as Nafion (registered trade name, available from DuPont), Aciplex (registered trade name, available from Asahi Kasei Corporation), Flemion (registered trade name, available from ASAHI GLASS Co., Ltd.); and fluorine based ion exchange membranes having an ammonium salt derivative group. Also exemplified are electrolyte membranes of hydrocarbon based electrolyte membranes such as styrene based graft polymers, trifluorostyrene derivative copolymers, sulfonated polyarylene ethers, sulfonated polyetherether ketones, sulfonated polyimides, sulfonated polybenzoimidazole, phosphonated polybenzoimidazole, sulfonated polyphosphazene, polyvinylpyridine, vinylbenzene polymer having an ammonium salt derivative group, aminated copolymer of chloromethylstyrene and vinylbenzene, and polyorthophenylenediamine.

Examples of inorganic membranes include membranes formed of phosphate glass, cesium hydrogen sulfide, polytungstophosphoric acid and ammonium polyphosphate. Examples of composite membranes include composite membranes of inorganic substances such as tungstic acid, cesium hydrogen sulfide and polytungstophosphoric acid, and organic substances such as polyimide, polyetheretherketone and perfluorosulfonic acid.

The film thickness of electrolyte membrane 101 is for example, 1 to 200 μm. EW value (dry weight per 1 mole of ion functional group) of electrolyte membrane 101 is preferably about 800 to 1100. The smaller the EW value, the smaller the resistance of the electrolyte membrane in association with ion migration is, and higher output can be obtained, however, it is practically difficult to make the value extremely small because of the problems of dimensional stability and strength of the electrolyte membrane.

(3) Anode Catalyst Layer and Cathode Catalyst Layer

Anode catalyst layer 102 stacked on one surface of electrolyte membrane 101 and cathode catalyst layer 103 stacked on the other surface are each formed of a porous layer containing a catalyst and an electrolyte. The catalyst of anode catalyst layer 102 has a function of oxidizing the fuel to generate an electron, and the catalyst of cathode catalyst layer 103 has a function of reducing oxygen in the air to consume an electron. The electrolyte contained in anode catalyst layer 102 and cathode catalyst layer 103 has a function of transferring ions involved in the aforementioned oxidation-reduction reaction between the anode catalyst layer and the cathode catalyst layer via electrolyte membrane 101.

Catalysts in anode catalyst layer 102 and cathode catalyst layer 103 may be carried on the surface of a conductor such as carbon or titanium, and it is particularly preferred that they are carried on the surface of a conductor such as carbon or titanium having a hydrophilic functional group such as hydroxyl group or carboxyl group. As a result, it is possible to improve the moisture retentivity of anode catalyst layer 102 and cathode catalyst layer 103. Further, it is preferred that electrolytes of anode catalyst layer 102 and cathode catalyst layer 103 are formed of materials having an EW value smaller than the EW value of electrolyte membrane 101, and concretely electrolyte materials having the same quality with electrolyte membrane 101 and having an EW value ranging from 400 to 800 are preferred. Also by using such electrolyte materials, it is possible to improve the moisture retentivity of anode catalyst layer 102 and cathode catalyst layer 103. By improvement of moisture retentivity of anode catalyst layer 102 and cathode catalyst layer 103, it is possible to ameliorate the resistance of electrolyte membrane 101 in association with ion migration and potential distribution in anode catalyst layer 102 and cathode catalyst layer 103. Further, since an electrolyte having a low EW value exhibits high fuel permeability as well, it is possible to uniformly supply the fuel to anode catalyst layer 102 by using the electrolyte having a low EW value.

(4) Anode Gas Diffusion Layer and Cathode Gas Diffusion Layer

The membrane electrode assembly of the present embodiment includes anode gas diffusion layer 104 stacked on a surface of anode catalyst layer 102 and cathode gas diffusion layer 105 stacked on a surface of cathode catalyst layer 103. Anode gas diffusion layer 104 and cathode gas diffusion layer 105 have a function of diffusing the fuel supplied to anode catalyst layer 102 and air supplied to cathode catalyst layer 103 respectively, in the plane, and a function of donating/receiving an electron to/from anode catalyst layer 102 cathode catalyst layer 103.

As anode gas diffusion layer 104 and cathode gas diffusion layer 105, it is preferred to use porous materials formed of carbon materials; conductive polymers; noble metals such as Au, Pt and Pd; transition metals such as Ti, Ta, W, Nb, Ni, Al, Cu, Ag and Zn; nitrides and carbides of these metals; and alloys containing these metals represented by stainless because they have low specific resistance and repress decrease in voltage. When metal having poor corrosion resistance under an acidic atmosphere, such as Cu, Ag or Zn is used, it may be subjected to a surface treatment (film formation) with noble metal having corrosion resistance such as Au, Pt or Pd, conductive polymer, conductive nitride, conductive carbide or conductive oxide. More concretely, as anode gas diffusion layer 104 and cathode gas diffusion layer 105, for example, foam metal, woven metal and sintered metal formed of the aforementioned noble metal, transition metal or alloy; and carbon paper, carbon cloth, an epoxy resin film containing carbon particles and the like can be preferably used.

While the membrane electrode assembly shown in FIG. 1 has been specifically described as one embodiment, the membrane electrode assembly of the present invention is not limited to the embodiment shown in FIG. 1. For example, the membrane electrode assembly of the present invention may be provided with the temperature responsive layer either on the anode electrode side or the cathode electrode side. Even when the temperature responsive layer is provided only on the anode electrode side, it is possible to repress the increase in the fuel permeation amount into the anode catalyst layer in association with temperature rise in the membrane electrode assembly, and to obtain the effects such as repression of thermal runway, repression of moisture evaporation from the electrolyte membrane, reduction in cell volume when it is applied in a fuel cell, improvement of reliability of the membrane electrode assembly and a fuel cell using the same, and repression of decrease in power generating efficiency in a fuel cell using the membrane electrode assembly. Further, even when the temperature responsive layer is provided only on the cathode electrode side, it is possible to obtain the effects such as repression of moisture evaporation from the electrolyte membrane in association with temperature rise in the membrane electrode assembly, repression of decrease in power generating efficiency in a fuel cell using the membrane electrode assembly, and reduction in cell volume when it is applied in a fuel cell.

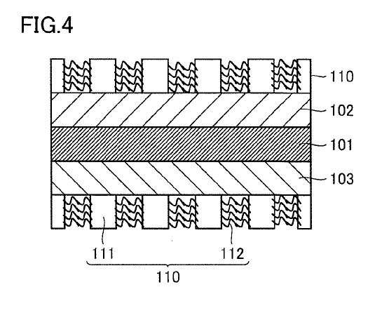

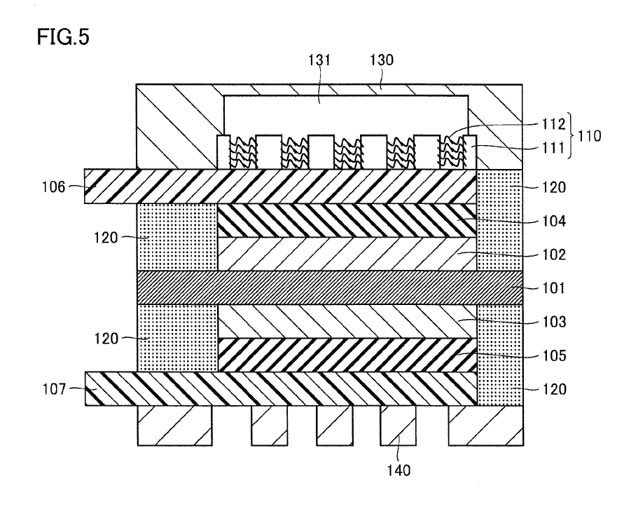

Further, the membrane electrode assembly of the present invention does not necessarily include the anode gas diffusion layer and the cathode gas diffusion layer, and these may be omitted in some cases. In such a case, the temperature responsive layer may be stacked on a surface of the anode catalyst layer and/or the cathode catalyst layer. Alternatively, the membrane electrode assembly of the present invention may include the temperature responsive layer as the anode gas diffusion layer and/or the cathode gas diffusion layer as shown in FIG. 4. That is, the temperature responsive layer in this case also has the functions of the anode gas diffusion layer and/or the cathode gas diffusion layer. The temperature responsive layer functioning also as the anode gas diffusion layer and/or the cathode gas diffusion layer is stacked on a surface of the anode catalyst layer and/or the cathode catalyst layer. By omitting the gas diffusion layer and using the temperature responsive layer functioning also as the gas diffusion layer, it is possible to reduce the volume of a fuel cell using the membrane electrode assembly. When an anode collector and a cathode collector are provided, the temperature responsive layer may be stacked on these collectors.

The temperature responsive layer functioning also as the gas diffusion layer is obtained by using as porous layer 111, a porous film commonly used as a gas diffusion layer such as carbon paper or carbon cloth. When the temperature responsive layer functioning also as the gas diffusion layer is used, it is preferred to appropriately adjust the fill amount of the temperature responsive material retained inside pores of the porous layer so that the function as the gas diffusion layer (the gas diffusing ability and the ability to supply the material to the catalyst layer) will be least inhibited.

The temperature responsive layer is not limited to the one formed of the porous layer containing the temperature responsive material, but it may be formed exclusively of the temperature responsive material, or may be formed of a non-temperature responsive network-structured polymer and a temperature responsive material retained in the network structure of the polymer. When the temperature responsive layer formed exclusively of the temperature responsive material is used, it is preferred to use the change between hydrophilicity/hydrophobicity of the temperature responsive polymer before and after the phase transition temperature for controlling the material permeability. The temperature responsive layer formed of the network-structured polymer and the temperature responsive material may be obtained by a method of dipping the network-structured polymer into a solution containing a monomer component forming the temperature responsive material to allow polymerization to proceed. The temperature responsive layer has an interpenetrating network structure, and even when the temperature responsive material swells or contracts due to temperature change, dimensional change of the temperature responsive layer is repressed by the network-structured polymer not having temperature responsibility. Examples of network-structured polymers include cross-linked poly(methyl methacrylate) and cross-linked polyvinyl chloride.

<Fuel Cell>

A fuel cell of the present invention includes the aforementioned membrane electrode assembly as a power generating unit, and preferably further includes an anode collector and a cathode collector for enabling collection of electrons and electric wiring, and a fuel supplying unit for supplying fuel to the anode catalyst layer provided on the side of the anode catalyst layer. FIG. 5 is a section view schematically showing one example of a fuel cell of the present invention. The fuel cell shown in FIG. 5 includes a laminate including anode catalyst layer 102, electrolyte membrane 101 and cathode catalyst layer 103 in this order, anode gas diffusion layer 104 stacked in contact with anode catalyst layer 102; cathode gas diffusion layer 105 stacked in contact with cathode catalyst layer 103; an anode collector 106 stacked in contact with anode gas diffusion layer 104; a cathode collector 107 stacked in contact with cathode gas diffusion layer 105; temperature responsive layer 110 stacked in contact with anode collector 106; an anode housing 130 disposed on anode collector 106; a cathode housing 140 stacked on cathode collector 107; and a gasket 120 that seals the end faces of the anode electrode and the cathode electrode.

(1) Anode Collector and Cathode Collector

Anode collector 106 and cathode collector 107 are stacked respectively on the anode electrode (for example, anode gas diffusion layer), and on the cathode electrode (for example, cathode gas diffusion layer), and have a function of collecting electrons in the anode electrode and the cathode electrode, and a function of configuring electric wiring. Materials of these collectors are preferably metal because the specific resistance is small and decrease in voltage is repressed even when the current is taken out in the planar direction, and among others, metal having electron conductivity and corrosion resistance under an acidic atmosphere is more preferred. Examples of such metal include noble metals such as Au, Pt and Pd; transition metals such as Ti, Ta, W, Nb, Ni, Al, Cu, Ag and Zn; nitrides and carbides of these metals; and alloys containing these metals represented by stainless. When metal having poor corrosion resistance under an acidic atmosphere such as Cu, Ag or Zn is used, it may be subjected to a surface treatment (film formation) with noble metal having corrosion resistance such as Au, Pt or Pd, conductive polymer, conductive nitride, conductive carbide, conductive oxide or the like. When the anode gas diffusion layer and the cathode gas diffusion layer are formed, for example, of metal or the like, and thus have relatively high conductivity, the anode collector and the cathode collector may be omitted.

More concretely, anode collector 106 may be a mesh-form or a punching metal-form flat plate formed of the aforementioned metal materials and so on, having a plurality of through-holes penetrating along the thickness for guiding the fuel to anode catalyst layer 102. This through-hole also functions as a discharge port for guiding the exhaust gas (carbon dioxide gas or the like) generated in anode catalyst layer 102 to the side of anode housing 130. Likewise, cathode collector 107 may be a mesh-form or a punching metal-form flat plate formed of the aforementioned metal materials and so on, having a plurality of through-holes penetrating along the thickness for supplying the air outside the fuel cell to cathode catalyst layer 103.

(2) Anode Housing

Anode housing 130 is a member constituting the fuel supply unit for supplying fuel to anode catalyst layer 102, provided on the anode electrode side, and in the fuel cell shown in FIG. 5, anode housing 130 is a member having a recess constituting a fuel supply chamber 131 for retaining or communicating the fuel. By stacking anode housing 130 on anode collector 106 so that the recess is opposed to anode collector 106, fuel supply chamber 131 is formed.

Anode housing 130 may be fabricated by forming a plastic material or a metal material into an appropriate shape having a recess forming the internal space of fuel supply chamber 131. Examples of plastic materials include polyphenylene sulfide (PPS), poly(methyl methacrylate) (PMMA), acrylonitrile butadiene styrene (ABS), polyvinyl chloride, polyethylene (PE), polyethylene terephthalate (PET), polyether ether ketone (PEEK), polytetrafluoroethylene (PTFE) and polyvinylidene fluoride (PVDF). Examples of metal materials that can be used include titanium and aluminum, as well as alloy materials such as stainless and magnesium alloys.

A method for supplying fuel from the fuel supply unit constituted by anode housing 130 to anode catalyst layer 102 is not particularly limited, and for example, a method of making fuel supply chamber 131 function as a fuel storage tank, and supplying the liquid fuel retained in fuel supply chamber 131 in a liquid state, or in a gas state to anode catalyst layer 102 via temperature responsive layer 110 is recited. Also, a method of providing a separate fuel storage tank connected with fuel supply chamber 131, guiding the liquid fuel retained in this fuel storage tank to fuel supply chamber 131, and then supplying it to anode catalyst layer 102 in a similar manner as described above may be adopted. In this case, fuel supply chamber 131 can function as a flow path for making the fuel reach the whole surface of anode catalyst layer 102. The fuel supply unit may further have a fuel transporting member formed of a material exhibiting capillary action for liquid fuel that extends from the fuel storage tank to inside fuel supply chamber 131. In this case, the liquid fuel retained in the fuel storage tank permeates from the end part on the fuel storage tank side of the fuel transporting member into the fuel transporting member and reaches inside fuel supply chamber 131, and then, it is typically supplied in a gas state from the fuel transporting member to anode catalyst layer 102. The fuel transporting member may be or may not be in contact with the temperature responsive layer.

Examples of the material exhibiting capillary action that forms the fuel transporting member include polymer materials (plastic materials) such as acrylic resins, ABS resin, polyvinyl chloride, polyethylene, polyethylene terephthalate, polyether ether ketone, fluorine resins such as polytetrafluoroethylene and cellulose, and porous bodies having irregular pores formed of metal materials such as stainless, titanium, tungsten, nickel, aluminum and steel. As the porous body, a nonwoven cloth, a foam, a sintered body and the like are recited. Examples of preferred materials include metal porous bodies formed of metal materials such as stainless, titanium, tungsten, nickel, aluminum and steel, in particular, a metal fiber nonwoven cloth obtained by processing the metal material into fibers to make a nonwoven cloth, and a sintered body of metal fiber nonwoven cloth obtained by sintering the metal fiber nonwoven cloth, followed by rolling as is necessary.

(3) Cathode Housing

Cathode housing 140 is a member for preventing the fuel cell from being directly exposed. Cathode housing 140 may sometimes be omitted. Cathode housing 140 is generally formed with one or two or more openings for introducing air into cathode catalyst layer 103. Cathode housing 140 may be fabricated by forming a plastic material or a metal material into an appropriate form. As the plastic material or the metal material, those similar to those described for anode housing 130 may be used.

According to the fuel cell of the present invention, since the membrane electrode assembly as described above is provided, it is possible to obtain the effects such as repression of increase in fuel permeation amount to the anode catalyst layer in association with temperature rise, repression of thermal runway, repression of moisture evaporation from the electrolyte membrane, reduction in cell volume, increase in reliability of the fuel cell and repression of reduction in power generating efficiency.

The fuel cell of the present invention may be applied as a solid polymer type fuel cell, or a direct alcohol type fuel cell, and it is particularly preferred as a direct alcohol type fuel cell (particularly, direct methanol type fuel cell). Examples of liquid fuels that can be used in the fuel cell of the present invention include alcohols such as methanol and ethanol; acetals such as dimethoxyethane; carboxylic acids such as formic acid; esters such as methyl formate; ethers such as dimethylether; and aqueous solutions thereof The liquid fuel is not limited to one kind, but may be a mixture of two or more kinds. From the points of low cost, high energy density per volume, low power generating efficiency and so on, a methanol aqueous solution or pure methanol is preferably used. The fuel cell of the present invention may be a passive type fuel cell that supplies fuel and air respectively to the anode electrode and the cathode electrode without using auxiliary machinery using external power such as a pump or a fan. Also in this case, according to the present invention, it is possible to effectively prevent crossover of the fuel and accompanying excessive temperature rise and thermal runway by the temperature responsive layer.

The fuel cell of the present invention may be suitably used as a power source for electronics, in particular for miniature electronics such as portable devices represented by a cellular phone, an electronic organizer, and a notebook computer.

### EXAMPLES

In the following, the present invention will be described more specifically by way of examples which are not intended to limit the present invention.

### Example 1

A membrane electrode assembly was fabricated in the following procedure, and then a fuel cell shown in FIG. 5 was fabricated.

(1) Fabrication of Membrane Electrode Assembly

Pt—Ru-carrying carbon black (“TEC66E50” available from Tanaka Kikinzoku Kogyo), Nafion (registered trade name) solution (“Nafion (registered trade name) 5% by weight solution, product number 527084” available from Sigma-Aldrich), and isopropyl alcohol were mixed by using an ultrasonic homogenizer. The obtained mixture was applied on one surface of a proton type Nafion 117 film (Product number 274674 available from Sigma-Aldrich) as an electrolyte membrane by spraying and dried to form an anode catalyst layer.

On the other hand, Pt-carrying carbon black (“TEC10E50E” available from Tanaka Kikinzoku Kogyo), Nafion (registered trade name) solution (“Nafion (registered trade name) 5% by weight solution, product number 527084” available from Sigma-Aldrich), and isopropyl alcohol were mixed by using an ultrasonic homogenizer. The obtained mixture was applied on the surface opposite to the anode catalyst layer of the Nafion 117 film by spraying and dried to form a cathode catalyst layer, and thus an electrolyte membrane coated with the catalysts (Catalyst Coated Membrane: CCM) was obtained.

Next, a gas diffusion layer (“GDL35BC” available from SGL) was placed on each of the anode catalyst layer and the cathode catalyst layer, and hot-pressed at 130° C. for 3 minutes, and thus the anode gas diffusion layer and the cathode gas diffusion layer were joined with the CCM.

Next, after irradiating a porous layer (porous film including “TEMISH (registered trade name) NTF1121” available from NITTO DENKO CORPORATION and polytetrafluoroethylene, porosity 90%) with radiation, the porous layer was dipped in a monomer solution dissolving 2-vinyl-2-oxazoline in N,N-dimethylformamide (concentration 10% by weight), to allow graft polymerization of polyethyloxazoline to the wall of pores of the porous layer. Then by hydrolysis with hydrochloric acid, a temperature responsive layer in which linear polyethyleneimine (temperature responsive material) is grafted to the wall of pores of the porous layer was obtained. Weight gain by the graft polymerization was 5.5% (weight gain was measured at room temperature, the same applies hereinafter).

Next, after disposing, on the anode gas diffusion layer, an anode collector formed of a stainless plate having gold-plated surface, and a large number of through-holes of 1 mm in diameter for allowing passage of fuel provided in the form of a honeycomb, and disposing, on the cathode gas diffusion layer, a cathode collector formed of a stainless plate having gold-plated surface, and a large number of through-holes of 1 mm in diameter for allowing passage of air provided in the form of a honeycomb, the temperature responsive layer obtained in the above was disposed on the anode collector, to obtain a membrane electrode assembly having a temperature responsive layer.

(2) Fabrication of Fuel Cell

On the anode collector of the membrane electrode assembly obtained in the above, an anode housing formed of acryl resin having a recess that forms a fuel supply chamber for retaining fuel was disposed, and on the cathode collector, a cathode housing formed of acryl resin having a plurality of openings for air supply was disposed, and further between the electrolyte membrane and the anode housing and the anode collector, and between the electrolyte membrane and the cathode housing and the cathode collector, a gasket formed of silicone rubber was disposed so as to prevent leakage of fuel and air, and the anode housing and the cathode housing were bolted together to obtain a fuel cell.

### Example 2

After irradiating a porous layer (porous film including “TEMISH (registered trade name) NTF1121” available from NITTO DENKO CORPORATION and polytetrafluoroethylene, porosity 90%) with plasma, the porous layer was dipped in a monomer solution dissolving N-isopropylmethacryl amide in a mixed solvent of 70% by weight of water and 30% by weight of methanol (concentration 10% by weight) to obtain a temperature responsive layer in which poly-N-isopropylmethacryl amide (temperature responsive material) is grafted to the wall of pores of the porous layer. Weight gain by the graft polymerization was 11.1%. A membrane electrode assembly was fabricated in a similar manner to Example 1 except that this temperature responsive layer was used, and a fuel cell was obtained in a similar manner to Example 1.

### Example 3

A monomer solution dissolving N-isopropylmethacryl amide and azobisisobutylonitrile (polymerization initiator) in a mixed solvent of 70% by weight of water and 30% by weight of methanol (concentration 10% by weight) was prepared. Next, both surfaces of a porous layer (porous film including “TEMISH (registered trade name) NTF1121” available from NITTO DENKO CORPORATION and polytetrafluoroethylene, porosity 90%) were covered with a mask (formed of polyphenylene sulfide) that was patterned into a grid form so that 50% of the surface was exposed, and both ends were secured with clips, and then the porous layer was dipped in the aforementioned monomer solution, and irradiated with ultraviolet ray, to obtain a temperature responsive layer wherein in the plane of the porous layer, region A consisting of pores filled with poly-N-isopropylmethacryl amide (temperature responsive material) and region B consisting of pores not filled with the same are arranged in a grid pattern, and the proportion of the area of region A is 50% of the surface of the porous layer. Weight gain by filling with poly-N-isopropylmethacryl amide was 6%. A membrane electrode assembly was prepared in a similar manner to Example 1 except that this temperature responsive layer was used, and a fuel cell was obtained in a similar manner to Example 1.

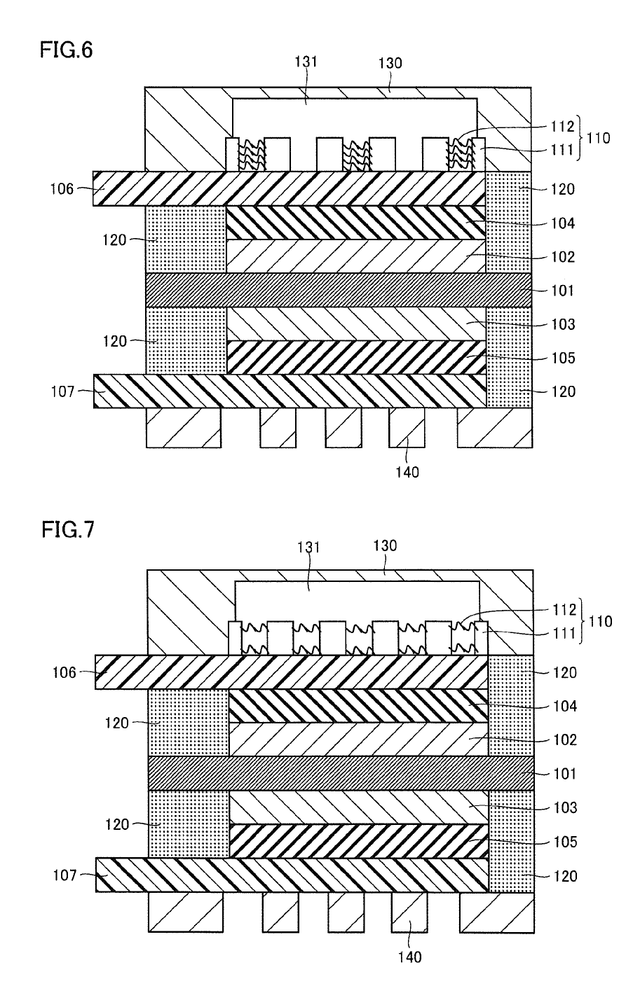

FIG. 6 is a section view schematically showing the fuel cell fabricated in Example 3. FIG. 6 resembles FIG. 5, but differs from FIG. 5 in that the region consisting of pores filled with temperature responsive material 112 and the region consisting of pores not filled the same are alternately arranged.

### Example 4

After irradiating a porous layer (porous film including “TEMISH (registered trade name) NTF1121” available from NITTO DENKO CORPORATION and polytetrafluoroethylene, porosity 90%) with plasma, the porous layer was dipped in a monomer solution dissolving N-isopropylmethacryl amide in methanol solvent (concentration 10% by weight) to obtain a temperature responsive layer in which poly-N-isopropylmethacryl amide (temperature responsive material) is grafted to the wall of pores of the porous layer. Weight gain by the graft polymerization was 7%. A membrane electrode assembly was fabricated in a similar manner to Example 1 except that this temperature responsive layer was used, and a fuel cell was obtained in a similar manner to Example 1.

FIG. 7 is a section view schematically showing the fuel cell fabricated in Example 4. FIG. 7 resembles FIG. 5, but differs from FIG. 5 in that the temperature responsive material has concentration distribution along a film thickness of the temperature responsive layer. By using methanol rather than a mixed solvent of methanol/water as a solvent in preparing the monomer solution, the polymerization speed is increased. At this time, since polymerization proceeds immediately after the monomer solution has permeated in pores, polymerization proceeds only in pores near the surface of the porous layer, and the polymer concentration is relatively low inside pores of the porous layer.

### Example 5

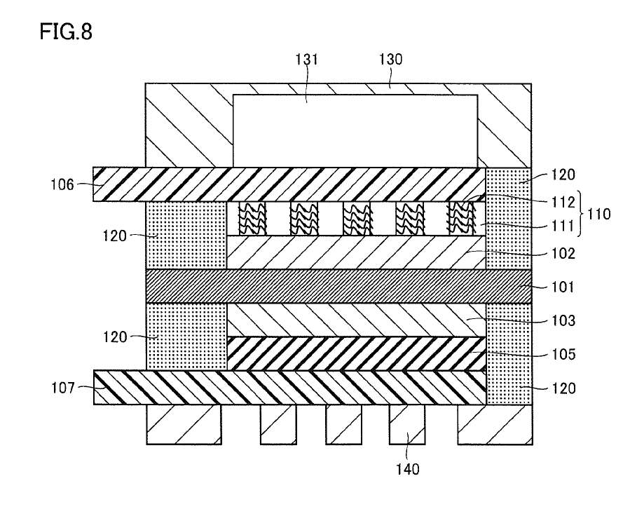

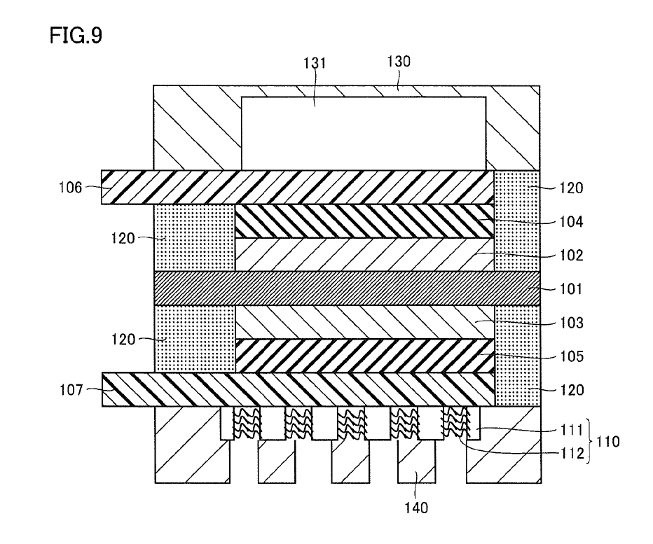

After irradiating a gas diffusion layer (“GDL35BC” available from SGL, porosity 80%) with radiation, the gas diffusion layer was dipped in a monomer solution dissolving 2-vinyl-2-oxazoline in N,N-dimethylformamide (concentration 10% by weight) to allow graft polymerization of polyethyloxazoline to the wall of pores of the gas diffusion layer. Then by hydrolysis with hydrochloric acid, a temperature responsive layer in which linear polyethyleneimine (temperature responsive material) is grafted to the wall of pores of the gas diffusion layer was obtained. Weight gain by the graft polymerization was 12.5%. A membrane electrode assembly was fabricated in a similar manner to Example 1 except that this temperature responsive layer was used as the anode gas diffusion layer in Example 1 and a temperature responsive layer was not stacked on the anode collector, and a fuel cell was obtained in a similar manner to Example 1. FIG. 8 is a section view schematically showing the fuel cell fabricated in Example 5.

### Example 6

A membrane electrode assembly was fabricated in a similar manner to Example 1 except that the temperature responsive layer fabricated in a method similar to Example 1 was disposed on the cathode collector rather than on the anode collector, and a fuel cell was obtained in a similar manner to Example 1. FIG. 9 is a section view schematically showing the fuel cell fabricated in Example 6.

### Example 7

A membrane electrode assembly was fabricated in a similar manner to Example 6 except that the temperature responsive layer fabricated in a method similar to Example 2 was used, and a fuel cell was obtained in a similar manner to Example 6.

### Example 8

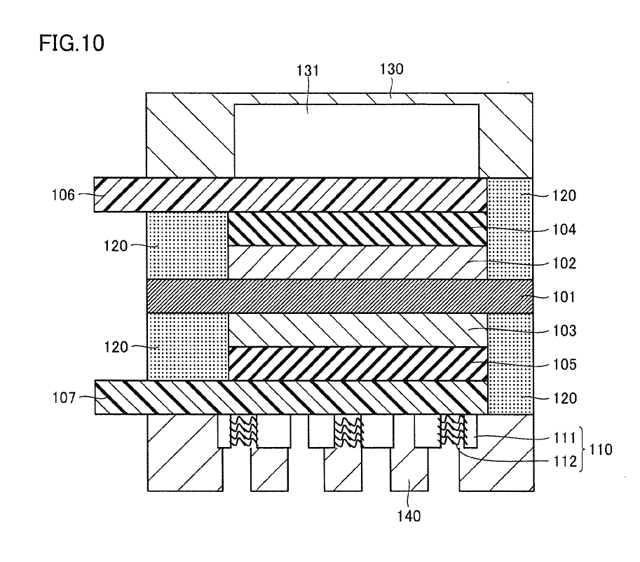

A membrane electrode assembly was fabricated in a similar manner to Example 6 except that the temperature responsive layer fabricated in a method similar to Example 3 was used, and a fuel cell was obtained in a similar manner to Example 6. FIG. 10 is a section view schematically showing the fuel cell fabricated in Example 8.

### Example 9

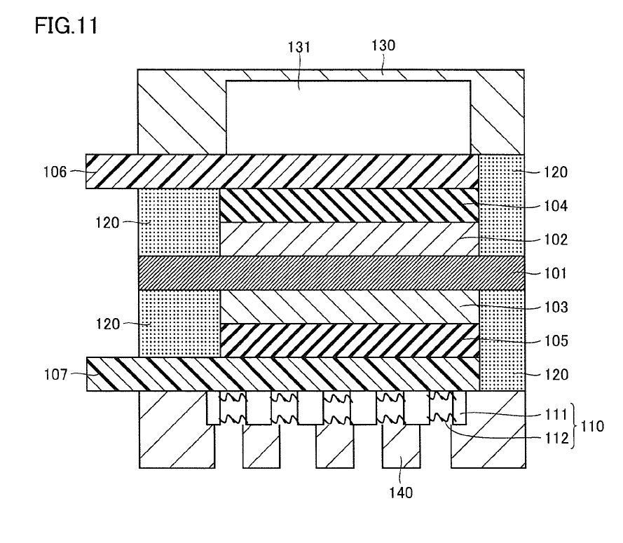

A membrane electrode assembly was fabricated in a similar manner to Example 6 except that the temperature responsive layer fabricated in a method similar to Example 4 was used, and a fuel cell was obtained in a similar manner to Example 6. FIG. 11 is a section view schematically showing the fuel cell fabricated in Example 9.

### Example 10

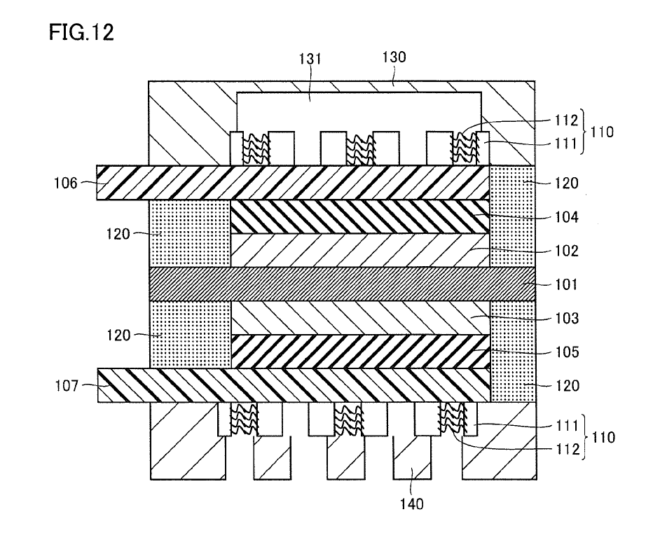

A membrane electrode assembly was fabricated in a similar manner to Example 1 except that the temperature responsive layer fabricated in a method similar to Example 1 was disposed on the anode collector and on the cathode collector, and a fuel cell was obtained in a similar manner to Example 1. FIG. 12 is a section view schematically showing the fuel cell fabricated in Example 10.

### Comparative Example 1

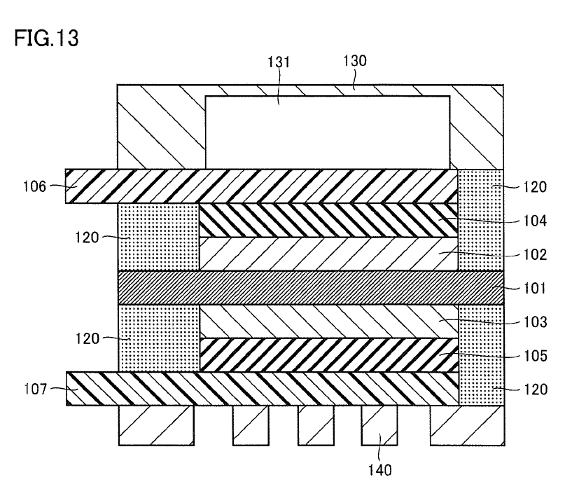

A membrane electrode assembly was fabricated in a similar manner to Example 1 except that a temperature responsive layer was not disposed on the anode collector, and a fuel cell was obtained in a similar manner to Example 1. FIG. 13 is a section view schematically showing the fuel cell fabricated in Comparative Example 1.

### Comparative Example 2

A temperature responsive layer was obtained in a similar manner to Example 1 except that concentration of 2-vinyl-2-oxazoline in the monomer solution was 15% by weight. Weight gain by the graft polymerization was 11%. A membrane electrode assembly was fabricated in a similar manner to Example 1 except that this temperature responsive layer was used, and a fuel cell was obtained in a similar manner to Example 1.

### Comparative Example 3

A temperature responsive layer was obtained in a similar manner to Example 2 except that concentration of N-isopropylmethacryl amide in the monomer solution was 5% by weight. Weight gain by the graft polymerization was 5.5%. A membrane electrode assembly was fabricated in a similar manner to Example 2 except that this temperature responsive layer was used, and a fuel cell was obtained in a similar manner to Example 2.

For temperature responsive layers and fuel cells fabricated in Examples and Comparative Examples, the following evaluations were conducted.

(1) Fill Amount of Temperature Responsive Material in Temperature Responsive Layer

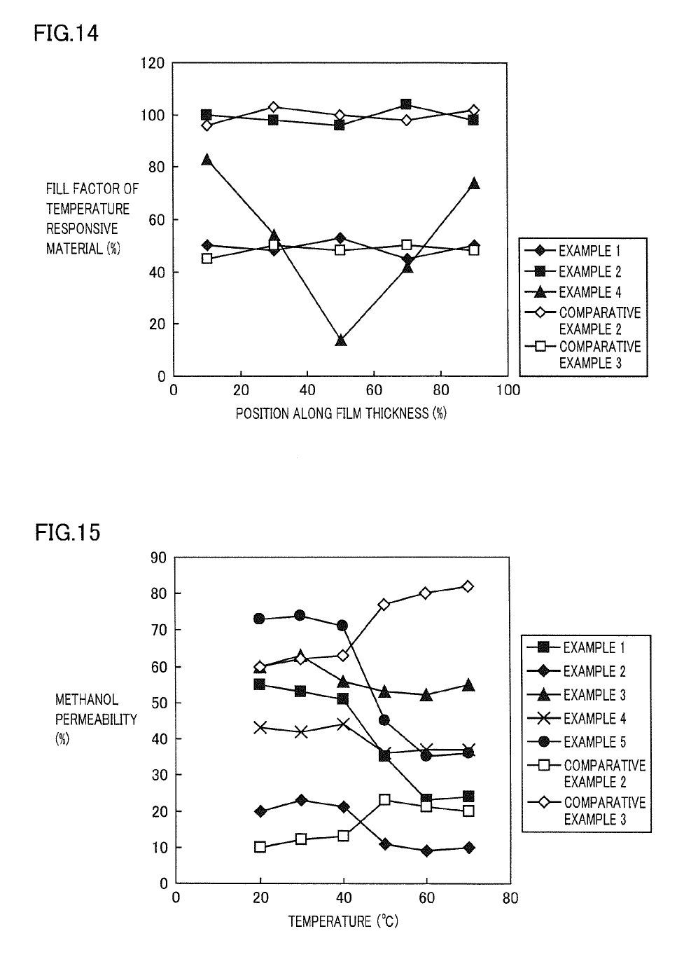

FIG. 14 is a view showing the relationship between the position along a film thickness of the temperature responsive layer fabricated in Examples 1, 2, 4, Comparative Examples 2 and 3, and the fill factor of the temperature responsive material retained on the porous layer. On the assumption that all pores in the porous layer are completely filled with a material having a density of 1 g/cm³, this is regarded “the fill factor of the temperature responsive material in every position along the film thickness is 100%”, and a fill factor of temperature responsive material in each temperature responsive layer was determined. In FIG. 14, 0% of the position along the film thickness means a first surface neighboring the membrane electrode assembly of two surfaces of the temperature responsive layer, and 100% means a second surface that is opposite to the first surface of the temperature responsive layer. In Example 2 and Comparative Example 2, the fill factor of the temperature responsive material was about 100% in every position along the film thickness. In Example 1 and Comparative Example 3, the fill factor of the temperature responsive material was about 50% in every position along the film thickness. In Example 4, the fill factor of the temperature responsive material was about 80% in the part near the surface of the temperature responsive layer, while the fill factor of the temperature responsive material was about 15% in the center part of the layer.

(2) Fuel Permeability of Temperature Responsive Layer

FIG. 15 is a view showing temperature dependency of methanol permeability of the temperature responsive layers fabricated in Examples 1 to 5 and Comparative Examples 2 to 3, measured by a pervaporation method. Methanol permeability (%) represents a relative value in relative to the methanol permeation amount at each temperature of 100 of the porous layer (porous film including “TEMISH (registered trade name) NTF1121” available from NITTO DENKO CORPORATION and polytetrafluoroethylene, porosity 90%). In the temperature responsive layers of Examples 1 to 5, it was verified that the methanol permeability dramatically decreases at about 40° C. (about 30° C. in Example 3) in association with temperature rise. On the other hand, in the temperature responsive layers of Comparative Examples 2 and 3, the methanol permeability dramatically increased at about 40° C. in association with temperature rise. When Examples 2 to 4 are compared, the response to temperature resembles among these, but methanol permeability at each temperature decrease in the order of Example 3>Example 4>Example 2. Further, in comparison with the temperature responsive layers of Examples 2 to 4, variation in methanol permeability in association with temperature change from the lower temperature to the higher temperature was larger in the temperature responsive layers of Examples 1 and 5. Here methanol permeability of a temperature responsive layer was evaluated; it is well presumable that a similar tendency is shown for moisture permeability.

(3) Power Generating Characteristics of Fuel Cell

[A] Fuel Cell Having Temperature Responsive Layer on Anode Electrode Side

A power generation test was conducted for the fuel cells of Examples 1 to 5 and Comparative Examples 2 to 3 having a temperature responsive layer only on the anode electrode side, and for the fuel cell of Comparative Example 1 not having a temperature responsive layer. The power generation test was conducted in a passive method wherein the fuel cell is placed in air atmosphere at room temperature, and a 5 M methanol aqueous solution is injected into a fuel supply chamber, and the fuel is supplied to the anode catalyst layer via the temperature responsive layer while the air is supplied to the cathode catalyst layer by natural convection. The applied voltage was set at 0.2 V, and resistance of the fuel cell, temperature of the fuel cell and current density were measured after one hour from starting of operation of the fuel cell. Also variation in temperature of the fuel cell during the term from one hour after starting of operation to two and a half hours after starting of operation, on the basis of the temperature of the fuel cell after one hour from starting of operation of the fuel cell was measured. The result is shown in Table 1.

TABLE 1

| | Value after 1 hour from start of operation | | | Temperature |
|---|---|---|---|---|
| | Resistance | Temperature | Current density | variation |
| | (Ω · cm²) | (° C.) | (mA/cm²) | (° C.) |
| Example 1 | 0.76 | 51 | 237 | 3 |
| Example 2 | 0.56 | 41 | 224 | 7 |
| Example 3 | 0.55 | 43 | 365 | 6 |
| Example 4 | 0.57 | 44 | 315 | 8 |
| Example 5 | 0.77 | 52 | 209 | 4 |
| Example 10 | 0.50 | 41 | 389 | 4 |
| Comparative | 1.32 | 63 | 192 | 5 |
| Example 1 | | | | |
| Comparative | 1.26 | 61 | 42 | 3 |
| Example 2 | | | | |
| Comparative | 1.29 | 63 | 163 | 2 |
| Example 3 | | | | |

While the temperature of the fuel cell after one hour from starting of operation increased to greater than or equal to 60° C., and the resistance exceeded 1.0 Ωcm² in Comparative Examples 1 to 3, the temperature of the fuel cell could be kept at less than 60° C. and the resistance could be kept at less than or equal to 1.0 Ωcm² in Examples 1 to 5. This is attributable to the fact that by providing the temperature responsive layer whose methanol permeability decreases in high temperature region on the anode electrode side, increase in methanol crossover in association with temperature rise can be prevented and rise in fuel cell temperature and accompanying moisture evaporation can be repressed. Also, in Examples 1 to 5, the obtainable current density increased in comparison with Comparative Examples 1 to 3, and this is attributable to the fact that the resistance of the fuel cell could be repressed to low level in comparison with Comparative Examples 1 to 3.

When Examples 2 to 4 are compared, the temperature of the fuel cell after one hour was comparable within a range of 41 to 44° C., but the obtained current density was different from each other. It is supposed that this difference is attributed to difference in methanol permeability of the temperature responsive layer being used, and when the temperature responsive layer having relatively large methanol permeability is used, the obtainable current density is large. Further, in Examples 1 and 5, variation in temperature of the fuel cell during the term from one hour after starting of operation to two and a half hours after starting of operation is small in comparison with Examples 2 to 4. This difference is attributable to use of a temperature responsive layer whose variation in methanol permeability is larger in Examples 1 and 5.

[B] Fuel Cell Having Temperature Responsive Layer on Cathode Electrode Side

A power generation test was conducted for the fuel cells of Examples 6 to 9 having a temperature responsive layer only on the cathode electrode side, and for the fuel cell of Comparative Example 1 not having a temperature responsive layer. The power generation test was conducted in a passive method wherein the fuel cell is placed in air atmosphere at room temperature, and a 3 M methanol aqueous solution is injected into a fuel supply chamber, and fuel is supplied to the anode catalyst layer via the temperature responsive layer while air is supplied to the cathode catalyst layer by natural convection. The applied current was set at 25 mA/cm², and resistance of the fuel cell, temperature of the fuel cell and voltage value were measured after one hour from starting of operation of the fuel cell. Immediately after this constant current measurement, the applied voltage was set at 0.2 V, and current density after 5 minutes was measured. The result is shown in Table 2.

TABLE 2

| | Value after 1 hour from start of operation | | | |
|---|---|---|---|---|
| | Resistance | Temperature | Voltage | Current density |
| | (Ω · cm²) | (° C.) | (mV) | (mA/cm²) |
| Example 6 | 0.62 | 53 | 444 | 198 |
| Example 7 | 0.59 | 51 | 456 | 98 |
| Example 8 | 0.66 | 49 | 423 | 265 |
| Example 9 | 0.64 | 50 | 437 | 250 |
| Comparative | 0.82 | 55 | 376 | 212 |
| Example 1 | | | | |

While the resistance of the fuel cell exceeded 0.8 Ωcm² in Comparative Example 1, the resistance of the fuel cell could be kept less than or equal to 0.8 Ωcm² in Examples 6 to 9. It is supposed that by providing the temperature responsive layer whose moisture permeability decreases in association with temperature rise on the cathode electrode side, dissipation of moisture from the fuel cell in association with temperature rise can be repressed even when the temperature of the fuel cell rises as a result of methanol crossover or power generation. In Examples 6 to 9, the obtained voltage was larger in comparison with Comparative Example 1, and this is attributable to the fact that in Examples 6 to 9, resistance of the fuel cell could be repressed to low level in comparison with Comparative Example 1.

When Examples 6 to 9 are compared, the obtained current density differs from each other. This difference is attributable to difference in material permeability of the temperature responsive layer being used, and the obtained current density is large when the temperature responsive layer having relatively large material permeability is used. While dissipation of moisture can be repressed by disposing the temperature responsive layer on the cathode electrode side, supply of air required for power generating reaction is also repressed in addition to the repression of permeation of moisture when the temperature responsive layer having small material permeability is disposed on the cathode electrode side. Therefore, it is supposed that the obtained current density is small when the material permeability of the temperature responsive layer is low.

[C] Fuel Cell Having Temperature Responsive Layers Both on Anode Electrode Side and Cathode Electrode Side

A power generation test was conducted for the fuel cell of Example 10 having temperature responsive layers both on the anode electrode side and the cathode electrode side. The power generation test was conducted in a passive method wherein the fuel cell is placed in air atmosphere at room temperature, and a 5 M methanol aqueous solution is injected into a fuel supply chamber, and fuel is supplied to the anode catalyst layer via the temperature responsive layer while air is supplied to the cathode catalyst layer by natural convection. The applied voltage was set at 0.2 V, and resistance of the fuel cell, temperature of the fuel cell and current density were measured after one hour from starting of operation of the fuel cell. Also variation in temperature of the fuel cell during the term from one hour after starting of operation to two and a half hours after starting of operation, on the basis of the temperature of the fuel cell after one hour from starting of operation of the fuel cell was measured. The result is shown in Table 1.

While the temperature of the fuel cell after one hour from starting of operation increased to greater than or equal to 60° C., and the resistance exceeded 1.0 Ωcm² in Comparative Example 1, the temperature of the fuel cell could be kept at less than 60° C. and the resistance could be kept at less than or equal to 1.0 Ωcm² in Example 10. This is attributable to the fact that by providing the temperature responsive layer whose methanol permeability decreases in high temperature region on the anode electrode side, increase in methanol crossover in association with temperature rise can be prevented, and rise in fuel cell temperature and accompanying moisture evaporation can be repressed.

In Example 10, the obtained current density was larger in comparison with Comparative Example 1, and this is attributable to the fact that the resistance of the fuel cell could be repressed to lower level in comparison with Comparative Example 1. When Example 1 and Example 10 are compared, lower resistance and higher current density were observed in Example 10. This is attributable to the fact that in Example 10, dissipation of moisture from the fuel cell in association with temperature rise in the fuel cell could be prevented more effectively because the temperature responsive layer was disposed also on the cathode electrode side.

### REFERENCE SIGNS LIST

10 water or methanol, 101 electrolyte membrane, 102 anode catalyst layer, 103 cathode catalyst layer, 104 anode gas diffusion layer, 105 cathode gas diffusion layer, 106 anode collector, 107 cathode collector, 110 temperature responsive layer, 111 porous layer, 112 temperature responsive material, 112a LCST type polymer, 112b UCST type polymer, 120 gasket, 130 anode housing, 131 fuel supply chamber, 140 cathode housing

1. A membrane electrode assembly having, on at least either one catalyst layer of an anode catalyst layer or a cathode catalyst layer in a laminate including said anode catalyst layer, an electrolyte membrane and said cathode catalyst layer in this order, a temperature responsive layer whose material permeability is reduced with temperature rise, wherein
said temperature responsive layer is composed of a porous layer and a temperature responsive polymer material whose moisture content changes at a phase transition temperature retained inside pores of said porous layer, and
said temperature responsive polymer material is retained only in part of pores among the pores included in said porous layer, or retained in pores in such a manner that fill density of said temperature responsive polymer material differs between one part and another part along a film thickness of said temperature responsive layer in the pores.

2. (canceled)

3. (canceled)

4. (canceled)

5. The membrane electrode assembly according to claim 1, wherein said temperature responsive polymer material is chemically bound to a wall of said pores of said porous layer.

6. (canceled)

7. (canceled)

8. The membrane electrode assembly according to claim 1, wherein said temperature responsive polymer material is a polymer material that exhibits upper critical solution temperature type phase transition behavior.

9. The membrane electrode assembly according to claim 1, wherein said temperature responsive polymer material is a polymer material that exhibits lower critical solution temperature type phase transition behavior.

10. The membrane electrode assembly according to claim 1, wherein a phase transition temperature of said temperature responsive polymer material is lower than a boiling point of fuel supplied to the anode catalyst layer by greater than or equal to 5° C.

11. The membrane electrode assembly according to claim 1, wherein said porous layer is composed of a non-temperature responsive material.

12. The membrane electrode assembly according to claim 1, further comprising an anode gas diffusion layer stacked on said anode catalyst layer and a cathode gas diffusion layer stacked on said cathode catalyst layer.

13. The membrane electrode assembly according to claim 12, wherein said temperature responsive layer is provided as said anode gas diffusion layer and/or said cathode gas diffusion layer.

14. A fuel cell comprising:
the membrane electrode assembly according to claim 1;
an anode collector stacked on the side of said anode catalyst layer of said membrane electrode assembly;
a cathode collector stacked on the side of said cathode catalyst layer of said membrane electrode assembly; and
a fuel supply unit disposed on the side of said anode catalyst layer of said membrane electrode assembly.

15. The fuel cell according to claim 14 which is a direct methanol type fuel cell.

16. The membrane electrode assembly according to claim 1, wherein said porous layer is a porous layer formed of fluorine based resin.

17. A direct alcohol type fuel cell comprising:
the membrane electrode assembly according to claim 16;
an anode collector stacked on the side of said anode catalyst layer of said membrane electrode assembly;
a cathode collector stacked on the side of said cathode catalyst layer of said membrane electrode assembly; and
a fuel supply unit disposed on the side of said anode catalyst layer of said membrane electrode assembly.

18. The direct alcohol type fuel cell according to claim 17, wherein said temperature responsive layer is disposed between said anode collector and said fuel supply unit.

19. The direct alcohol type fuel cell according to claim 18, wherein said fuel supply unit includes a fuel supply chamber which is a space disposed above said temperature responsive layer, a fuel storage tank for retaining fuel, and a fuel transporting member formed of a material exhibiting capillary action for fuel that extends from said fuel storage tank to said fuel supply chamber.

20. The direct alcohol type fuel cell according to claim 17, wherein said temperature responsive layer is disposed on said cathode collector.
